(19) United States
(12) Patent Application Publication
(10) Pub. No.: US 2026/0011241 A1
(43) Pub. Date: Jan. 8, 2026

(54) AUTHENTICATION METHOD FOR EMERGENCY VEHICLES TO QUICKLY PASS THROUGH TRAFFIC LIGHTS

(71) Applicant: Hangzhou Normal University, Hangzhou (CN)

(72) Inventors: Qi Xie, Hangzhou (CN); Juanjuan Huang, Hangzhou (CN); Xiumei Li, Hangzhou (CN); Qingyun Xie, Hangzhou (CN); Yining Liu, Hangzhou (CN); Anjia Yang, Hangzhou (CN)

(21) Appl. No.: 18/908,832

(22) Filed: Oct. 8, 2024

(30) Foreign Application Priority Data
Jul. 5, 2024 (CN) 202410898674.1

(51) Int. Cl. G08G 1/087; H04L 9/40

(52) U.S. Cl. CPC G08G 1/087; H04L 63/0435

(57) ABSTRACT

The proposed invention discloses an authentication method for emergency vehicles to quickly pass through traffic lights, which relates to the field of information security technology. The method designs a traffic light service request message propagation and handover authentication structure by considering that traffic lights are located in different roadside unit domains, enabling emergency vehicles to quickly pass through multiple traffic lights until they reach the intended destination. By introducing elliptic curve encryption operations on critical parameters during the authentication process, the security of the entire authentication process is enhanced, effectively resisting various known attacks. The adoption of elliptic curve Diffie-Hellman secret exchange values for authentication ensures the legitimacy of identities. Vehicles employ a dynamic anonymity strategy to protect privacy, avoiding the transmission of identity-related information over public channels and achieving privacy protection.

### TECHNICAL FIELD

The proposed invention relates to the field of information security technology, specifically, a method for the authentication of emergency vehicles to pass through traffic lights quickly.

### BACKGROUND

The Internet of Vehicles (IoV) is an essential component of intelligent transportation systems and has been widely implemented in smart cities in recent years. The Internet of Vehicles refer to the wireless connection of vehicles to the internet using communication technologies, enabling real-time data exchange and communication between vehicles, the external environment, and infrastructure. It utilizes technologies such as onboard sensors, communication modules, and cloud platforms to transform vehicles into intelligent terminals, facilitating interconnectedness and communication between vehicles and infrastructure.

Currently, the commonly used method for emergency vehicles to pass through traffic lights quickly is to directly run red lights. However, this method carries a high risk and can easily lead to secondary accidents. Some studies are leveraging artificial intelligence and deep learning technologies to address traffic light scheduling problems, but there is currently no optimal solution. While there is considerable research on identity authentication in vehicular communication, there is a lack of dedicated authentication protocols specifically designed for enabling emergency vehicles to pass through traffic lights rapidly.

### SUMMARY

The purpose of the proposed invention is to provide an authentication method for emergency vehicles to pass through traffic lights quickly. This method aims to enhance the security for emergency vehicles to pass through traffic lights quickly and achieve privacy protection.

To achieve the above objectives, the proposed invention provides the following solution:

An authentication method for emergency vehicles to pass through traffic lights quickly, comprising:

### S1. System Initialization

The trusted authority (TA) selects a finite field Fₚ, a large prime number p, and an elliptic curve E: y²=x³+ax+b(mod p), where a, b∈Fₚ, G is the additive group with prime order q, P is a generator. Meanwhile, TA chooses a secure one-way hash function h:

$${\{ 0 , 1 \}}^{*} \to {Z}_{q}^{*} ,$$

and randomly chooses a number s

$$∈ {Z}_{q}^{*}$$

as the system's private key, and calculates the PK_{TA}=s·P as the corresponding public key. TA publishes system parameters params={G, E, P, p, q, a, b, h, PK_{TA}}.

### S2. Registration Phase

TA generates registration information for the emergency vehicles (EVs), roadside units (RSUs), and traffic control units (TCUs). Once each unit receives feedback on the registration information, the resulting secret parameters are protected and securely stored using physically unclonable functions (PUFs).

### S3. Authentication Phase

The authentication process for emergency vehicles to quickly pass traffic lights is as follows:

The emergency vehicle sends a traffic light message request to the nearest roadside unit. Upon receiving the message, the roadside unit first authenticates the legitimacy of the emergency vehicle's identity.

After successful authentication, the roadside unit determines whether there are traffic lights within its area. If a traffic light is present, the roadside unit sends the message to the traffic control unit inside the traffic light. The traffic control unit responds by sending feedback to the roadside unit. If no traffic light is present, the roadside unit generates its own feedback message and sends it to the emergency vehicle.

Once the emergency vehicle receives feedback messages from the roadside unit, it will evaluate the feedback information. If there is traffic light, the vehicle and traffic control unit will perform mutual authentication, quickly pass the traffic light, and send a service completion message to the traffic control unit. If there is no traffic light, the vehicle will proceed directly to the next roadside unit domain.

The specific process of the registration phase includes:

### S2.1. Emergency Vehicle Registration

The emergency vehicle EVᵢ selects an identity IDᵢ, a private key vⱼ, and calculates the corresponding public key PK_{EVi}=vᵢ·P. Then EVᵢ transmits {IDᵢ, PK_{EVi}} to the TA through a secure channel. TA selects a random number γᵢ and calculates the pseudonym PEVᵢ for the emergency vehicle EVᵢ as PEVᵢ=Encₛ(γᵢ∥IDᵢ). TA randomly selects a random number xᵢ and calculates Xᵢ=xᵢ·P. It also computes the identity verification parameter Certᵢ as Certᵢ=h(PEVᵢ∥Xᵢ∥PK_{EVi}∥PK_{TA})·s+xᵢ. TA then sends {Certᵢ, PEVᵢ, Xᵢ} to EVᵢ. When emergency vehicle EVᵢ receives the message, the driver verifies if Certᵢ·P=h(PEVᵢ∥Xᵢ∥PK_{Evi}∥PK_{TA})·PK_{TA}+Xᵢ is correct. If it is correct, the driver inputs their biometric information BIOᵢ and computes (αᵢ, βᵢ)=Gen(BIOᵢ). The onboard unit (OBU) of the vehicle selects a challenge value Cᵢ and calculates the response value Rᵢ=PUF(Cᵢ). It also computes

$${v}_{i}^{*} = {v}_{i} ⊕ h ( {R}_{i} \vert \vert 1 ) , {Cert}_{i}^{*} = {Cert}_{i} ⊕ h ( {R}_{i} \vert \vert 2 ) , P R {V}_{i}^{*} = P E {V}_{i} ⊕ h ( {R}_{i} \vert \vert 3 ) ,$$

$${C}_{i}^{*} = h ( C e r {t}_{i} \vert \vert {PEV}_{i} \vert \vert {R}_{i} \vert \vert {v}_{i} \vert \vert {α}_{i} \vert \vert {ID}_{i} ) mod {n}_{0} ,$$

where n₀∈(2⁴, 2⁸). Finally,

$$\{ Rep ( \cdot ) , {β}_{i} , {v}_{i}^{*} , P R {V}_{i}^{*} , C e r {t}_{i}^{*} , {C}_{i}^{*} , {X}_{i} , {PK}_{EVi} , {n}_{0} , {C}_{i} \}$$

are stored in the OBU.

### S2.2. Roadside Units Registration

Firstly, TA selects a random integer uⱼ and an identity RIDⱼ for each roadside unit RSUⱼ (j=1, 2, 3, . . . ). The corresponding public key PKRSUⱼ is then calculated as PK_{RSUj}=uⱼ·P. Then, TA selects a shared secret value δₜ for the roadside unit RSUⱼ and its corresponding traffic control unit TCUₜ. It calculates Zⱼ=h(δₜ∥PK_{RSUj}∥RIDⱼ) and sends {uⱼ, δₜ, RIDⱼ, Zⱼ} to RSUⱼ. When the roadside unit RSUⱼ receives the message, it computes the corresponding public key PK_{RSUj}=uⱼ·P and verifies if

$${Z}_{j}^{*} = h ( {δ}_{t} ‖ {PK}_{RSUj} ‖ {RID}_{j} )$$

is equal to Zⱼ. If they are equal, the roadside unit RSUⱼ selects a challenge value Cⱼ, calculates Rⱼ=PUF(Cⱼ), and updates its values as follows:

$${δ}_{t}^{*} = {δ}_{t} ⊕ h ( {R}_{j} ‖ {RID}_{j} ) and {u}_{j}^{*} = {u}_{j} ⊕ h ( {RID}_{j} ‖ {R}_{j} ) .$$

Finally, RSUⱼ stores

$$\{ {C}_{j} , {δ}_{t}^{*} , {u}_{j}^{*} , {PK}_{RSUj} , {RID}_{j} \}$$

in its storage unit.

### S2.3. Traffic Control Unit Registration

Firstly, the TA selects a corresponding identity TIDₜ for the traffic control unit TCUₜ (t=1, 2, 3, . . . ). It then sends {δₜ, TIDₜ} to the traffic control unit TCUₜ over a secure channel, where δₜ is a shared secret value used for fast communication between the roadside unit RSUⱼ and the corresponding traffic control unit TCUₜ. When the traffic control unit TCUₜ receives the registration information from the trusted authority TA, it selects a challenge value Cₜ and calculates the corresponding response value Rₜ=PUF(Cₜ). Then, it computes

$${δ}_{t}^{*} = {δ}_{t} ⊕ h ( {R}_{t} ‖ {TID}_{t} ) )$$

and finally stores

$$\{ {δ}_{t}^{*} , {TID}_{t} \} .$$

The specific process of the authentication phase includes:

### S3.1. Sending Request Message

The emergency vehicle EVᵢ sends a request message for quickly through the traffic lights to the roadside unit RSUⱼ. When a driver wants to operate an emergency vehicle EVᵢ, the user must input their identity IDᵢ and biometric information BIOᵢ to verify legitimacy. Then, the emergency vehicle EVᵢ uses the recovery function and βᵢ of a fuzzy extractor to compute the biometric key αᵢ=Rep(BIOᵢ, βᵢ). It also calculates

$${R}_{i} = PU F ( {C}_{i} ) , {v}_{i} = {v}_{i}^{*} ⊕ h ( {R}_{i} \vert \vert 1 ) , C e r {t}_{i} = Cer {t}_{i}^{*} ⊕ h ( {R}_{i} \vert \vert 2 ) ,$$

and pseudonym

$$P E {V}_{i} = P R {V}_{i}^{*} ⊕ h ( {R}_{i} ‖ 3 ) .$$

Next, the emergency vehicle EVᵢ computes

$${C}_{i}^{′} = h ( {Cert}_{i} ‖ {PEV}_{i} ‖ {R}_{i} ‖ {v}_{i} ‖ {α}_{i} ‖ {ID}_{i} ) mod {n}_{0}$$

and compares it with Cᵢ* stored in the onboard unit OBU. If they are not equal, re-login is required; otherwise, it indicates that the driver is legitimate, and the driver authentication is successful. When the emergency vehicle EVᵢ wants to pass through a traffic light intersection unimpeded, it sends a request message to the nearest roadside unit. Firstly, the emergency vehicle EVᵢ generates two random numbers r₁ and r₂, then computes M₁=r₁·P, M₂=Encₕ₍₍ᵣ_{₁}_{·PK}_{_{RSUj}}_{)∥T}_{₁}₎(r₂∥Xᵢ∥PK_{EVi}∥PEVᵢ∥M₁∥m₁∥T₁), where PK_{EVi} is the public key of the emergency vehicle EVᵢ, PEVᵢ is the pseudonym of the emergency vehicle EVᵢ. The emergency vehicle EVᵢ computes M₃=h(T₁∥PEVᵢ∥Xᵢ∥PK_{EVi}∥m₁∥PK_{TA}∥T₁)·vᵢ+Certᵢ, and sends {M₂, M₃, T₁} to the nearest roadside unit RSUⱼ. When RSUⱼ receives the messages, it first checks the timestamp T₁. If the timestamp is fresh, the nearest roadside unit RSUⱼ computes Rⱼ=PUF(Cⱼ) and recovers the private key

$${u}_{j} = {u}_{j}^{*} ⊕ h ( {RID}_{j} \vert \vert {R}_{j} ) ,$$

then decrypts (r₂∥Xᵢ∥PK_{EVi}∥PEVᵢ∥M₁∥m₁∥T₁)=Decₕ₍₍ᵤ_{ⱼ}_{·M}_{₁}_{)∥T}_{₁}₎(M₂) to get parameter Xᵢ, public key PK_{EVi}, pseudonym PEVᵢ, the point M₁ on the elliptic curve, request message m₁ quickly through traffic lights. Next, the nearest roadside unit RSUⱼ verifies if M₃·P [symbol] h(T₁∥PEVᵢ∥Xᵢ∥PK_{EVi}∥m₁∥PK_{TA}∥T₁)·PK_{EVi}+h(PEVᵢ∥Xᵢ∥PK_{EVi})·PK_{TA}+Xᵢ is correct. If it is correct, the nearest roadside unit RSUⱼ selects a random number r₃, and computes the shared secret key sk_{ER}=h(r₃·M₁) for the convenience of subsequent communication, including EV-to-TCU and EV-to-RSU. Otherwise, authentication is terminated immediately and the emergency vehicle resends the request.

### S3.2. Existing Traffic Lights

RSUⱼ sends a quickly pass the traffic lights request message to TCUₜ. If there is a traffic light within the range of the roadside unit RSUⱼ, the roadside unit RSUⱼ communicates with the traffic control unit TCUₜ. The roadside unit RSUⱼ generates timestamp T₂, and computes

$${δ}_{t} = {δ}_{t}^{*} ⊕ h ( {R}_{j} \vert \vert {RID}_{j} ) , {M}_{4} = E n {c}_{h ( {δ}_{t} \vert \vert {T}_{2} )} ( {m}_{1} \vert \vert {sk}_{E R} \vert \vert {PEV}_{i} ) ,$$

$${M}_{5} = h ( {m}_{1} \vert \vert {sk}_{E R} \vert \vert {RID}_{j} \vert \vert PE {V}_{i} \vert \vert {δ}_{t} {T}_{2} ) .$$

Then, the roadside unit RSUⱼ sends {M₄, M₅, RIDⱼ, T₂} to the traffic control units TCUₜ. When the traffic control units TCUₜ receives the messages from the roadside unit RSUⱼ, the traffic control units TCUₜ firstly checks the freshness of timestamp T₂. If the timestamp is fresh, the traffic control unit TCUₜ computes the response value Rₜ=PUF(Cₜ), recovers the shared secret value

$${δ}_{t} = {δ}_{t}^{*} ⊕ h ( {R}_{t} ‖ {TID}_{t} ) ,$$

and based on the shared secret value and symmetric decryption algorithm between the roadside unit RSUⱼ and the traffic control unit TCUₜ, decrypts (m₁∥sk_{ER}∥PEVᵢ)=Dec_{h(δ}_{ₜ}_{∥T}_{₂}₎(M₄). Next, the traffic control unit TCUₜ computes

$${M}_{5}^{*} = h ( {m}_{1} ‖ {sk}_{E R} ‖ {RID}_{j} ‖ {PEV}_{i} ‖ {δ}_{t} ‖ {T}_{2} ) ,$$

and verifies

$${M}_{5} {=}^{?} {M}_{5}^{*} .$$

If the verification fails, the authentication process will immediately terminate. If the verification is successful, the traffic control unit TCUₜ saves the shared key

$$s {k}_{E R}^{*} = {sk}_{E R} ⊕ h ( {TID}_{t} \vert \vert {R}_{t} )$$

and generates feedback message m₂. It then stores

$$< {m}_{1} , {m}_{2} , {PEV}_{i} , {sk}_{E R}^{*} > .$$

Meanwhile, the traffic control unit TCUₜ generates a timestamp T₃, and computes M₆=m₂⊕h(δₜ∥T₃) for encrypting the transmission of feedback message m₂. It also calculates M₇=h(m₂∥TIDₜ∥δₜ∥PEVᵢ∥T₃) for verifying the integrity of each parameter. Finaly, it sends {M₆, M₇, T₃} to the roadside unit RSUⱼ. When the roadside unit RSUⱼ receives the information from the traffic control unit TCUₜ, it checks the timestamp T₃. If the time is fresh, the roadside unit RSUⱼ recovers the feedback message m₂=M₆⊕h(δₜ∥T₃), and calculates

$${M}_{7}^{*} = h ( {m}_{2} ‖ {TID}_{t} ‖ {δ}_{t} ‖ {PEV}_{i} ‖ {T}_{3} )$$

to verity if

$${M}_{7} {=}^{?} {M}_{7}^{*}$$

is correct. If the verification fails, the authentication process will immediately terminate. If the verification is successful, the roadside unit RSUⱼ sends a message to the emergency vehicle EVᵢ.

### S3.3. Sending Feedback Message

The process by which the roadside unit RSUⱼ sends feedback messages to the emergency vehicle EVᵢ and EVᵢ receives feedback messages. The roadside unit RSUⱼ selects the timestamp T₄ and calculates M₈=r₃·P based on elliptic curve algorithm, where r₃ is a random number. Simultaneously, RSUⱼ calculates M₉=(m₂)⊕h(r₂∥sk_{ER}∥T₄) using the shared key sk_{ER} for encrypting the transmission of feedback message m₂. RSUⱼ also calculates M₁₀=h(M₉∥r₂∥m₂∥sk_{ER}∥M₈∥RIDⱼ∥T₄) for verifying the integrity of each parameter. RSUⱼ then sends {M₈, M₉, M₁₀, RIDⱼ, T₄} to the emergency vehicle EVᵢ. When the emergency vehicle EVᵢ receives a message from the roadside unit RSUⱼ, EVᵢ checks the timestamp T₄. If the timestamp is fresh, EVᵢ calculates the shared key sk_{ER}=h(r₁, M₈), recovers the feedback message (m₂)=M₉⊕h(r₂∥sk_{ER}∥T₄), and verifies its validity by calculating M₁₀*=h(M₉∥r₂∥m₂∥sk_{ER}∥M₈∥RIDⱼ∥T₄) and comparing it with M₁₀. If the verification is successful, EVᵢ stores the shared key sk_{ER} and proceeds to cross the traffic light at the fastest speed.

### S3.4. No Existing Traffic Lights

If there is no traffic light within the domain of the roadside unit RSUⱼ, RSUⱼ generates a feedback message m₂* indicating that there is no traffic light for direct passage and selects the timestamp T₄. Following the procedure outlined in S3.3, RSUⱼ sends the message to the emergency vehicle EVᵢ. The only difference is that the feedback message m₂ generated by the traffic control unit TCUₜ is replaced by

$${m}_{2}^{*} .$$

### S3.5. Service Completion

Traffic control unit TCUₜ adjusts traffic light to complete service. When the emergency vehicle EVᵢ approaches the traffic light, EVᵢ generates a timestamp T₅. Using a symmetric encryption algorithm, EVᵢ encrypts the feedback message m₂ and the emergency vehicle pseudonym PEVᵢ as M₁₁=EnCₛₖ_{_{ER}}(m₂∥PEVᵢ∥T₅). EVᵢ then sends the message {m₂, M₁₁, T₅} to the traffic control unit TCUₜ for transmission. When the traffic control unit TCUₜ receives messages from the emergency vehicle EVᵢ, TCUₜ first checks the timestamp T₅. If the timestamp is fresh, TCUₜ uses the feedback information m₂ to find the corresponding <m₁, m₂,

$${PEV}_{i} , {sk}_{ER}^{*} > \cdot {TCU}_{t}$$

then recovers the session key sk_{ER} by performing the operation

$$s {k}_{E R} = s {k}_{E R}^{*} ⊕ h ( {TID}_{t} \vert \vert {R}_{t} ) .$$

Next, TCUₜ decrypts

$$( {m}_{2} ‖ {PEV}_{i}^{*} ‖ {T}_{5} )$$

by using the decryption function

$$( {m}_{2} \vert \vert PE {V}_{i}^{*} \vert \vert {T}_{5} ) = D e {c}_{s {κ}_{E R}} ( {M}_{11} ) .$$

TCUₜ compares the computer pseudonym

$${PEV}_{i}^{*}$$

with the stored pseudonym PEVᵢ. If they are identical, it indicates that the task message is from the emergency vehicle EVᵢ. TCUₜ adjusts the traffic light accordingly to facilitate the emergency vehicle's quick passage and concludes the service.

### S3.6. Transmitting Request Message

The current roadside unit RSUⱼ forwards the traffic light request message to the next roadside unit RSUⱼ₊₁. The roadside unit RSUⱼ generates timestamp T₆, and calculates M₁₂=Encₕ₍₍ᵤ_{ⱼ}_{·PK}_{_{RSUj+1}}_{)∥T}_{₆}₎(m₁∥sk_{ER}∥PEVᵢ) using symmetric encryption. RSUⱼ also calculates M₁₃=h(m₁∥sk_{ER}∥PEVᵢ∥M₁₂∥RIDⱼ∥RIDⱼ₊₁∥T₆), and sends {M₁₂, M₁₃, RIDⱼ, T₆} to the next roadside unit RSUⱼ₊₁. When the next roadside unit RSUⱼ₊₁ receives messages from the current roadside unit RSUⱼ, the next roadside unit RSUⱼ₊₁ firstly checks timestamp T₆. If the timestamp is fresh, the next roadside unit RSUⱼ₊₁ computes response value Rⱼ₊₁=PUF(Cⱼ₊₁) and recovers private key

$${u}_{j + 1} = {u}_{j + 1}^{*} ⊕ h ( {RID}_{j + 1} ‖ {R}_{j + 1} ) .$$

Then RSUⱼ₊₁ decrypts (m₁∥sk_{ER}∥PEVᵢ) as

$$( {m}_{1} ‖ {sk}_{ER} ‖ {PEV}_{i} ) = {Dec}_{h ( ( {u}_{j + 1} \cdot {PK}_{RSUj} ) ‖ {T}_{6} )} ( {M}_{12} ) ,$$

obtains the requested message m₁, the shared secret key sk_{ER} and the emergency vehicle pseudonym PEVᵢ. RSUⱼ₊₁ validates the decrypted parameters by calculating

$${M}_{13}^{*} = h ( {m}_{1} ‖ {sk}_{ER} ‖ {PEV}_{i} ‖ {M}_{12} ‖ {RID}_{j} ‖ {RID}_{j + 1} ‖ {T}_{6} )$$

and comparing it with M₁₃ to check for equality. If the validation is successful, RSUⱼ₊₁ calculates

$${sk}_{ER}^{*} = {sk}_{ER} ⊕ h ( {RID}_{j + 1} ‖ {R}_{j + 1} )$$

to be used for encrypting and storing the shared key sk_{ER}. Finally, RSUⱼ₊₁ stores the tuple

$$〈 {m}_{1} , {PEV}_{i} , {sk}_{ER}^{*} 〉 .$$

If there is a traffic light within the current roadside unit RSUⱼ, the roadside unit RSUⱼ₊₁ follows the procedure outlined in S3.2 to transmit vehicle information to the traffic control unit TCU responsible for controlling the current traffic light. It then receives feedback message m₂. Subsequently, the emergency vehicle EVᵢ, after entering the next roadside unit RSUⱼ₊₁, communicates with the TCU within the domain and swiftly passes through the traffic light, following a similar process as before. However, if the roadside unit RSUⱼ₊₁ does not have a traffic light, it provides feedback to the emergency vehicle EVᵢ and forwards the vehicle's information to the subsequent roadside unit RSUⱼ₊₂.

Optionally, the specific method for timestamp verification is as follows:

$$\vert {T}_{n}^{′} - {T}_{n} \vert \leq Δ T$$

Where Tₙ is the timestamp included in the message received in the previous phase,

$${T}_{n}^{′}$$

is the current timestamp obtained by the device upon receiving the message, and ΔT is the threshold time allowed during the predetermined communication process. If the time difference exceeds the threshold time, the time is not fresh, the authentication process is terminated. If the time difference is less than the threshold time, the next step is carried out.

The messages {M₂, M₃, T₁}, {M₄, M₅, RIDⱼ, T₂}, {M₆, M₇, T₃}, {M₈, M₉, M₁₀, RIDⱼ, T₄}, {m₂, M₁₁, T₅} and {M₁₂, M₁₃, RIDⱼ, T₆} are all transmitted over a public channel.

According to specific embodiments provided by the proposed invention, the following technical effects are disclosed:

The invention discloses an authentication method for emergency vehicles to pass traffic lights quickly. The method designs a traffic light service request message propagation and handover certification structure by taking into account that different traffic lights are in different roadside unit domains, so that emergency vehicles can pass through multiple traffic lights quickly until the emergency vehicle arrives at a predetermined location. By introducing elliptic curve cryptography to encrypt key parameters in the authentication process, the security of the whole authentication process is improved, and the known attacks are effectively resisted. The elliptic curve Diffie-Hellman secret exchange value is used to authenticate the two communication parties, which ensures the legitimacy of identity. All vehicles use dynamic anonymity policies to protect privacy, and do not transmit identity-related information on open channels to achieve privacy protection.

### BRIEF DESCRIPTION OF DRAWINGS

In order to provide a clearer illustration of the embodiments of the proposed invention or the technical solutions in the prior art, a brief introduction to the drawings used in the embodiments will be provided below. It is evident that the following description of the drawings is merely some embodiments of the proposed invention. Ordinary skilled persons in the field can obtain other drawings based on these drawings without exercising inventive effort.

FIG. 1 illustrates the system architecture of authentication method for the emergency vehicle pass traffic lights rapidly in the proposed invention.

FIG. 2 illustrates the overall flowchart of the authentication process for the quick pass traffic lights in this embodiment.

FIG. 3 illustrates the shared secret key generation process in this embodiment.

FIG. 4 illustrates the feedback message generation process in this embodiment.

FIG. 5 illustrates the process of emergency vehicles storing shared keys in this embodiment.

FIG. 6 illustrates the flowchart of the service termination process for an individual traffic light in this embodiment.

### DETAILED DESCRIPTION OF EMBODIMENTS

The following description provides a clear and comprehensive explanation of the technical solutions in the embodiments of the proposed invention, in conjunction with the accompanying drawings. It is evident that the described embodiments are only a part of the embodiments of the proposed invention, rather than the entirety of the embodiments. Based on the embodiments of the proposed invention, all other embodiments that ordinary skilled persons in the field can obtain without exercising inventive effort are within the scope of protection of the proposed invention.

The objective of the proposed invention is to provide an authentication method of emergency vehicles to rapidly pass through traffic lights, aiming to enhance the security of emergency vehicles pass through traffic lights rapidly and achieve privacy protection.

To make the above objectives, features, and advantages of the proposed invention more apparent and understandable, further detailed explanations of the proposed invention will be provided below in conjunction with the accompanying drawings and specific embodiments.

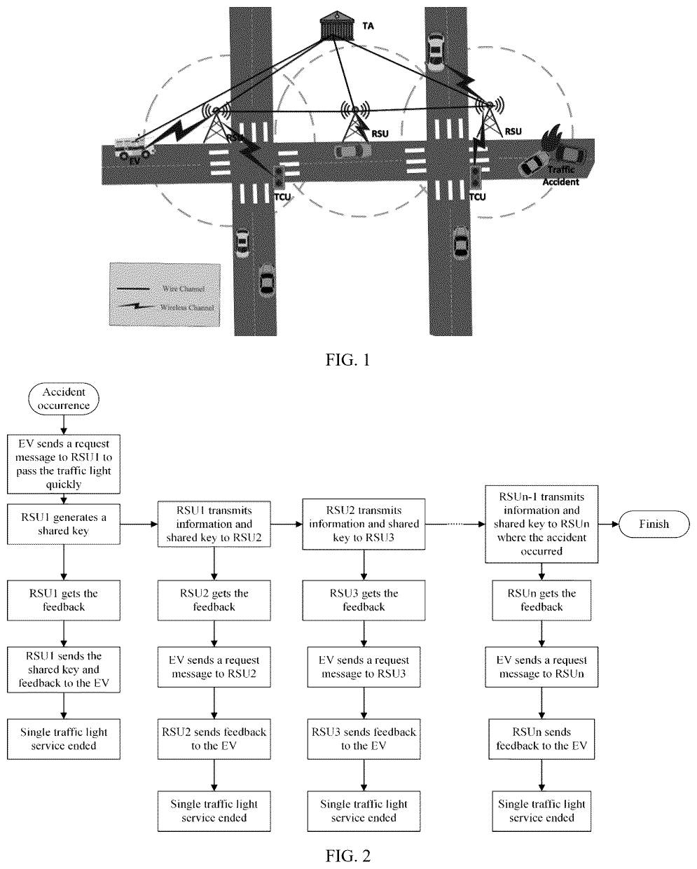

As shown FIG. 1, the proposed invention provides a V2I (Vehicle-to-Infrastructure) authentication protocol to address the emergency vehicles pass traffic lights rapidly. Considering the possibility of multiple traffic lights intersection along the rescue route, a traffic light service request message propagation and transfer authentication architecture has been designed.

After an accident occurs, the emergency vehicle sends a traffic light message request to the nearest roadside unit in advance. Upon receiving the message, the roadside unit first verifies the legitimacy of the vehicle's identity. If the authentication is successful, it checks if there is a traffic light within its area. If a traffic light exists, the roadside unit sends a message to the traffic control unit in the traffic light, and the traffic control unit returns a feedback message to the roadside unit. If there is no traffic light, the roadside unit generates a feedback message and sends it to the emergency vehicle. Once the roadside unit sends the response message to the vehicle, the vehicle takes appropriate actions based on the feedback message. If a traffic light exists, the vehicle contacts the traffic control unit and quickly passes through the traffic light. After the vehicle rapidly passes through the traffic light, it sends a service completion message to the traffic control unit. If there is no traffic light, the vehicle proceeds directly to the next roadside unit domain. The nearest roadside unit passes the message to the next roadside unit in advance to prepare for the vehicle's arrival. The subsequent authentication process follows a similar pattern until the emergency vehicle reaches the accident scene.

The protocol is based on elliptic curve cryptography and achieves conditional privacy protection and mutual authentication. The proposed protocol allows emergency vehicles to undergo rapid authentication with subsequent roadside units after completing the initial mutual authentication with the nearest roadside unit, avoiding cumbersome computational processes. Additionally, each roadside unit sends request messages in advance to the traffic control units of the traffic lights within its jurisdiction, ensuring the timely arrangement of the traffic light system. Furthermore, at the start of the emergency vehicle, the protocol introduces the validation of the driver's identity, and a trusted center can hold individuals accountable for malicious behavior. The design also incorporates the use of physical unclonable functions and biometric keys to protect the privacy information of both the roadside units and the emergency vehicles, mitigating the risk of key leakage.

Specifically, the protocol includes the following steps:

### S1. System Initialization.

The trusted authority (TA) selects a finite field Fₚ, a large prime number p, and an elliptic curve E: y²=x³+ax+b(mod p), where a, b∈Fₚ, G is the additive group with prime order q, P is a generator. Meanwhile, TA chooses a secure one-way hash function h:

$${\{ 0 , 1 \}}^{*} \to {Z}_{q}^{*} ,$$

and randomly chooses a number

$$s ∈ {Z}_{q}^{*}$$

as the system's private key, and calculates the PK_{TA}=s·P as the corresponding public key. TA publishes system parameters params={G, E, P, p, q, a, b, h, PK_{TA}}.

### S2. Registration Phase.

TA generates registration information for the emergency vehicles (EVs), roadside units (RSUs), and traffic control units (TCUs). Once each unit receives feedback on the registration information, the resulting secret parameters are protected and securely stored using physically unclonable functions (PUFs). Specifically, the steps include:

### S2.1. Emergency Vehicle Registration

The emergency vehicle EVᵢ selects an identity IDᵢ, a private key vⱼ, and calculates the corresponding public key PK_{EVi}=vᵢ·P. Then EVᵢ transmits {IDᵢ, PK_{EVi}} to the TA through a secure channel. TA selects a random number γᵢ and calculates the pseudonym PEVᵢ for the emergency vehicle EVᵢ as PEVᵢ=Encₛ(γᵢ∥IDᵢ). TA randomly selects a random number xᵢ and calculates Xᵢ=xᵢ·P. It also computes the identity verification parameter Certᵢ as Certᵢ=h(PEVᵢ∥Xᵢ∥PK_{EVi}∥PK_{TA})·s+xᵢ. TA then sends {Certᵢ, PEVᵢ, Xᵢ} to EVᵢ. When emergency vehicle EVᵢ receives the message, the driver verifies if Certᵢ·P=h(PEVᵢ∥Xᵢ∥PK_{EVi}∥PK_{TA})·PK_{TA}+Xᵢ is correct. If it is correct, the driver inputs their biometric information BIOᵢ and computes (αᵢ, βᵢ)=Gen(BIOᵢ). The onboard unit (OBU) of the vehicle selects a challenge value Cᵢ and calculates the response value Rᵢ=PUF(Cᵢ). It also computes

$${v}_{i}^{*} = {v}_{i} ⊕ h ( {R}_{i} ‖ 1 ) , {Cert}_{i}^{*} = {Cert}_{i} ⊕ h ( {R}_{i} ‖ 2 ) , \\ {PRV}_{i}^{*} = {PEV}_{i} ⊕ h ( {R}_{i} ‖ 3 ) , {C}_{i}^{*} = h ( {Cert}_{i} ‖ {PEV}_{i} ‖ {R}_{i} ‖ {v}_{i} ‖ {α}_{i} ‖ {ID}_{i} ) mod {n}_{0} ,$$

where n₀∈(2⁴, 2⁸). Finally,

$$\{ Rep ( \cdot ) , {β}_{i} , {v}_{i}^{*} , {PRV}_{i}^{*} , {Cert}_{i}^{*} , {C}_{i}^{*} , {X}_{i} , {PK}_{EVi} , {n}_{0} , {C}_{i} \}$$

are stored in the OBU.

### S2.2. Roadside Units Registration

Firstly, TA selects a random integer uⱼ and an identity RIDⱼ for each roadside unit RSUⱼ (j=1, 2, 3, . . . ). The corresponding public key PK_{RSUj} is then calculated as PK_{RSUj}=uⱼ·P. Then, TA selects a shared secret value δₜ for the roadside unit RSUⱼ and its corresponding traffic control unit TCUₜ. It calculates Zⱼ=h(δₜ∥PK_{RSUj}∥RIDⱼ) and sends {uⱼ, δₜ, RIDⱼ, Zⱼ} to RSUⱼ. When the roadside unit RSUⱼ receives the message, it computes the corresponding public key PK_{RSUj}=uⱼ·P and verifies if

$${Z}_{j}^{*} = h ( {δ}_{t} ‖ {PK}_{RSUj} ‖ {RID}_{j} )$$

is equal to Zⱼ. If they are equal, the roadside unit RSUⱼ selects a challenge value Cⱼ, calculates Rⱼ=PUF(Cⱼ), and updates its values as follows:

$${δ}_{t}^{*} = {δ}_{t} ⊕ h ( {R}_{j} ‖ {RID}_{j} ) and {u}_{j}^{*} = {u}_{j} ⊕ h ( {RID}_{j} ‖ {R}_{j} ) .$$

Finally, RSUⱼ stores

$$\{ {C}_{j} , {δ}_{t}^{*} , {u}_{j}^{*} , {PK}_{RSUj} , {RID}_{j} \}$$

### S2.3. Traffic Control Unit Registration

Firstly, the TA selects a corresponding identity TIDₜ for the traffic control unit TCUₜ (t=1, 2, 3, . . . ). It then sends {δₜ, TIDₜ} to the traffic control unit TCUₜ over a secure channel, where δₜ is a shared secret value used for fast communication between the roadside unit RSUⱼ and the corresponding traffic control unit TCUₜ. When the traffic control unit TCUₜ receives the registration information from the trusted authority TA, it selects a challenge value Cₜ and calculates the corresponding response value Rₜ=PUF(Cₜ). Then, it computes δₜ*=δₜ⊕h(Rₜ∥TIDₜ) and finally stores {δₜ*, TIDₜ}.

### S3. Authentication Phase

The specific process of the authentication phase includes:

The emergency vehicle sends a traffic light message request to the nearest roadside unit. Upon receiving the message, the roadside unit first authenticates the legitimacy of the emergency vehicle's identity.

After successful authentication, the roadside unit determines whether there is traffic light within its area. If a traffic light is present, the roadside unit sends the message to the traffic control unit inside the traffic light. The traffic control unit responds by sending feedback to the roadside unit. If no traffic light is present, the roadside unit generates its own feedback message and sends it to the emergency vehicle.

Once the emergency vehicle receives feedback messages from the roadside unit, it will evaluate the feedback information. If there is traffic light, the vehicle and traffic control unit will perform mutual authentication, quickly pass the traffic light, and send a service completion message to the traffic control unit. If there is no traffic light, the vehicle will proceed directly to the next roadside unit domain.

The specific process of the authentication phase is as follows:

### S3.1. Sending Request Message

The emergency vehicle EVᵢ sends a request message for quick passage through the traffic lights to the roadside unit RSUⱼ. When a driver wants to operate an emergency vehicle EVᵢ, the user must input their identity IDᵢ and biometric information BIOᵢ to verify legitimacy. Then, the emergency vehicle EVᵢ uses the recovery function and βᵢ of a fuzzy extractor to compute the biometric key αᵢ=Rep (BIOᵢ, βᵢ). It also calculates Rᵢ=PUF(Cᵢ),

$${v}_{i} = {v}_{i}^{*} ⊕ h ( {R}_{i} ‖ 1 ) , {Cert}_{i} = {Cert}_{i}^{*} ⊕ h ( {R}_{i} ‖ 2 ) ,$$

and pseudonym

$${PEV}_{i} = {PRV}_{i}^{*} ⊕ h ( {R}_{i} ‖ 3 ) .$$

Next, the emergency vehicle EVᵢ computes

$${{C}_{i}}^{′} = h ( {Cert}_{i} ‖ {PEV}_{i} ‖ {R}_{i} ‖ {v}_{i} ‖ {α}_{i} ‖ {ID}_{i} ) mod {n}_{0}$$

and compares it with Cᵢ* stored in the onboard unit OBU. If they are not equal, re-login is required; otherwise, it indicates that the driver is legitimate, and the driver authentication is successful. When the emergency vehicle EVᵢ wants to pass through a traffic light intersection unimpeded, it sends a request message to the nearest roadside unit. Firstly, the emergency vehicle EVᵢ generates two random numbers r₁ and r₂, then computes M₁=r₁·P,

$${M}_{2} = {Enc}_{h ( ( {r}_{1} \cdot {PK}_{RSUj} ) ‖ {T}_{1} )} ( {r}_{2} ‖ {X}_{i} ‖ {PK}_{EVi} ‖ {PEV}_{i} ‖ {M}_{1} ‖ {m}_{1} ‖ {T}_{1} ) ,$$

where PK_{EVi} is the public key of the emergency vehicle EVᵢ, PEVᵢ is the pseudonym of the emergency vehicle EVᵢ. The emergency vehicle EVᵢ computes M₃=h(T₁∥PEVᵢ∥Xᵢ∥PK_{EVi}∥m₁∥PK_{TA}∥T₁)·vᵢ+Certᵢ, and sends {M₂, M₃, T₁} to the nearest roadside unit RSUⱼ. When RSUⱼ receives the messages, it first checks the timestamp T₁. If the timestamp is fresh, the nearest roadside unit RSUⱼ computes Rⱼ=PUF(Cⱼ) and recovers the private key

$${u}_{j} = {u}_{j}^{*} ⊕ h ( {RID}_{j} ‖ {R}_{j} ) ,$$

then decrypts (r₂∥Xᵢ∥PK_{EVi}∥PEVᵢ∥M₁∥m₁∥T₁)=Decₕ₍₍ᵤ_{ⱼ}_{·M}_{₁}_{)∥T}_{₁}₎(M₂) to get parameter Xᵢ, public key PK_{EVi}, pseudonym PEᵢ, the point M₁ on the elliptic curve, Request message m₁ quickly through traffic lights. Next, the nearest roadside unit RSUⱼ verifies if M₃·P [symbol] h(T₁∥PEVᵢ∥Xᵢ∥PK_{EVi}∥m₁∥PK_{TA}∥T₁)·PK_{EVi}+h(PEVᵢ∥Xᵢ∥PK_{EVi}). PK_{TA}+Xᵢ is correct. If it is correct, the nearest roadside unit RSUⱼ selects a random number r₃, and computes the shared secret key sk_{ER}=h(r₃·M₁) for the convenience of subsequent communication, including EV-to-TCU and EV-to-RSU. Otherwise, authentication is terminated immediately and the emergency vehicle resends the request.

### S3.2. Existing Traffic Lights

RSUⱼ sends a quick pass traffic-lights request message to TCUₜ. If there is a traffic light within the range of the roadside unit RSUⱼ, the roadside unit RSUⱼ communicates with the traffic control unit TCUₜ. The roadside unit RSUⱼ generates timestamp T₂, and computes

$${δ}_{t} = {δ}_{t}^{*} ⊕ h ( {R}_{j} ‖ {RID}_{j} ) , {M}_{4} = {Enc}_{h ( {δ}_{t} ‖ {T}_{2} )} ( {m}_{1} ‖ {sk}_{ER} ‖ {PEV}_{i} ) ,$$

M₅=h(m₁∥sk_{ER}∥RIDⱼ∥PEVᵢ∥δₜ∥T₂). Then, the roadside unit RSUⱼ sends {M₄, M₅, RIDⱼ, T₂} to the traffic control units TCUₜ. When the traffic control units TCUₜ receives the messages from the roadside unit RSUⱼ, the traffic control units TCUₜ firstly checks timestamp T₂. If the timestamp is fresh, the traffic control unit TCUₜ computes the response value Rₜ=PUF(Cₜ), recovers the shared secret value

$${δ}_{t} = {δ}_{t}^{*} ⊕ h ( {R}_{t} ‖ {TID}_{t} ) ,$$

and based on the shared secret value and symmetric decryption algorithm between the roadside unit RSUⱼ and the traffic control unit TCUₜ, decrypts (m₁∥sk_{ER}∥PEVᵢ)=Dec_{h(δ}_{ₜ}_{∥T}_{₂}₎(M₄). Next, the traffic control unit TCCₜ computes

$${M}_{5}^{*} = h ( {m}_{1} ‖ {sk}_{E R} ‖ {RID}_{j} ‖ {PEV}_{i} ‖ {δ}_{t} ‖ {T}_{2} ) ,$$

and verifies

$${M}_{5} {=}^{?} {M}_{5}^{*}$$

It the verification tails, the authentication process will immediately terminate. If the verification is successful, the traffic control unit TCUₜ saves the shared key

$$s {k}_{E R}^{*} = {sk}_{E R} ⊕ h ( {TID}_{t} ‖ {R}_{t} )$$

and generates feedback message m₂. It then stores

$$〈 {m}_{1} , {m}_{2} , {PEV}_{i} , {sk}_{E R}^{*} 〉 .$$

Meanwhile, the traffic control unit TCUₜ generates a timestamp T₃, and computes M₆=m₂⊕h(δₜ∥T₃) for encrypting the transmission of feedback message m₂. It also calculates M₇=h(m₂∥TIDₜ∥δₜ∥PEVᵢ∥T₃) for verifying the integrity of each parameter. Finaly, it sends {M₆, M₇, T₃} to the roadside unit RSUⱼ. When the roadside unit RSUⱼ receives the information from the traffic control unit TCUₜ, it checks the timestamp T₃. If the timestamp is fresh, the roadside unit RSUⱼ recovers the feedback message m₂=M₆⊕h(δₜ∥T₃), and calculates

$${M}_{7}^{*} = h ( {m}_{2} ‖ {TID}_{t} ‖ {δ}_{c} ‖ {PEV}_{i} ‖ {T}_{3} )$$

to verily if

$${M}_{7} {=}^{?} {M}_{7}^{*}$$

is correct. If the verification fails, the authentication process will immediately terminate. If the verification is successful, the roadside unit RSUⱼ sends a message to the emergency vehicle EVᵢ.

### S3.3. Sending Feedback Message

The process by which the roadside unit RSUⱼ sends feedback messages to the emergency vehicle EVᵢ and EVᵢ receives feedback messages. The roadside unit RSUⱼ selects the timestamp T₄ and calculates M₈=r₃·P based on elliptic curve algorithm, where r₃ is a random number. Simultaneously, RSUⱼ calculates M₉=(m₂)⊕h(r₂∥sk_{ER}∥T₄) using the shared key sk_{ER} for encrypting the transmission of feedback message m₂. RSUⱼ also calculates M₁₀=h(M₉∥r₂∥m₂∥sk_{ER}∥M₈∥RIDⱼ∥T₄) for verifying the integrity of each parameter. RSUⱼ then sends {M₈, M₉, M₁₀, RIDⱼ, T₄} to the emergency vehicle EVᵢ. When the emergency vehicle EVᵢ receives a message from the roadside unit RSUⱼ, EVᵢ checks the timestamp T₄. If the timestamp is fresh, EVᵢ calculates the shared key sk_{ER}=h(r₁·M₈), recovers the feedback message (m₂)=M₉⊕h(r₂∥sk_{ER}∥T₄), and verifies its validity by calculating M₁₀*=h(M₉∥r₂∥m₂∥sk_{ER}∥M₈∥RIDⱼ∥T₄) and comparing it with M₁₀. If the verification is successful, EVᵢ stores the shared key sk_{ER} and proceeds to cross the traffic light at the fastest speed.

### S3.4. No Existing Traffic Lights

If there is no traffic light within the domain of the roadside unit RSUⱼ, RSUⱼ generates a feedback message

$${m}_{2}^{*}$$

indicating that there is no traffic light for direct passage and selects the timestamp T₄. Following the procedure outlined in S3.3, RSUⱼ sends the message to the emergency vehicle EVᵢ. The only difference is that the feedback message m₂ generated by the traffic control unit TCUₜ is replaced by

$${m}_{2}^{*} .$$

### S3.5. Service Completion

Traffic control unit TCUₜ adjusts traffic light to complete service. When the emergency vehicle EVᵢ approaches the traffic light, EVᵢ generates a timestamp T₅. Using a symmetric encryption algorithm, EVᵢ encrypts the feedback message m₂ and the emergency vehicle pseudonym PEVᵢ as M₁₁=EnCₛₖ_{_{ER}}(m₂∥PEVᵢ∥T₅). EVᵢ then sends the message {m₂, M₁₁, T₅} to the traffic control unit TCUₜ for transmission. When the traffic control unit TCUₜ receives messages from the emergency vehicle EVᵢ, TCUₜ first checks the timestamp T₅. If the timestamp is fresh, TCUₜ uses the feedback information m₂ to find the corresponding <m₁, m₂, PEVᵢ,

$$s {k}_{E R}^{*} 〉 . {TCU}_{t}$$

then recovers the session key sk_{ER} by performing the operation

$$s {k}_{E R} = s {k}_{E R}^{*} ⊕ h ( {TID}_{t} ‖ {R}_{t} ) .$$

Next, TCUₜ decrypts

$$( {m}_{2} ‖ {PEV}_{i}^{*} ‖ {T}_{5} )$$

by using the decryption function (m₂∥PEVᵢ*∥T₅)=Decₛₖ_{_{ER}}(M₁₁). TCUₜ compares the computed pseudonym

$$P E {V}_{i}^{*}$$

with the stored pseudonym PEVᵢ. If they are identical, it indicates that the task message is from the emergency vehicle EVᵢ. TCUₜ adjusts the traffic light accordingly to facilitate the emergency vehicle's quick passage and concludes the service.

### S3.6. Transmitting Request Message

The current roadside unit RSUⱼ forwards the traffic light request message to the next roadside unit RSUⱼ₊₁. The roadside unit RSUⱼ generates timestamp T₆, and calculates M₁₂=Enc_{h((uj·PK}_{_{RSUj+1}}_{)∥T}_{₆}₎(m₁∥sk_{ER}∥PEVᵢ) using symmetric encryption. RSUⱼ also calculates M₁₃=h(m₁∥sk_{ER}∥PEVᵢ∥M₁₂∥RIDⱼ∥RIDⱼ₊₁∥T₆), and sends {M₁₂, M₁₃, RIDⱼ, T₆} to the next roadside unit RSUⱼ₊₁. When the next roadside unit RSUⱼ₊₁ receives messages from the current roadside unit RSUⱼ, the next roadside unit RSUⱼ₊₁ firstly checks timestamp T₆. If the timestamp is fresh, the next roadside unit RSUⱼ₊₁ computes response value Rⱼ₊₁=PUF(Cⱼ₊₁) and recovers private key

$${u}_{j + 1} = {u}_{j + 1}^{*} ⊕ h ( {RID}_{j + 1} ‖ {R}_{j + 1} ) .$$

Then RSUⱼ₊₁ decrypts (m₁∥sk_{ER}∥PEVᵢ) as (m₁∥sk_{ER}∥PEVᵢ)=Decₕ₍ᵤ_{ⱼ₊₁}_{·PK}_{_{RSUj}}_{)∥T}_{₆})(M₁₂), obtains the requested message m₁, the shared secret key sk_{ER} and the emergency vehicle pseudonym PEVᵢ. RSUⱼ₊₁ validates the decrypted parameters by calculating

$${M}_{13}^{*} = h ( {m}_{1} ‖ {sk}_{E R} ‖ {PEV}_{i} ‖ {M}_{12} ‖ {RID}_{j} ‖ {RID}_{j + 1} ‖ {T}_{6} )$$

and comparing it with M₁₃ to check for equality. If the validation is successful, RSUⱼ₊₁ calculates

$$s {k}_{E R}^{*} = {sk}_{E R} ⊕ h ( {RID}_{j + 1} ‖ {R}_{j + 1} )$$

to be used for encrypting and storing the shared key sk_{ER}. Finally, RSUⱼ₊₁ stores the tuple <m₁, PEVᵢ,

$$s {k}_{E R}^{*} 〉 .$$

If there is a traffic light within the current roadside unit RSUⱼ, the roadside unit RSUⱼ₊₁ follows the procedure outlined in S3.2 to transmit vehicle information to the traffic control unit TCU responsible for controlling the current traffic light. It then receives feedback message m₂. Subsequently, the emergency vehicle EVᵢ, after entering the next roadside unit RSUⱼ₊₁, communicates with the TCU within the domain and swiftly passes through the traffic light, following a similar process as before. However, if the roadside unit RSUⱼ₊₁ does not have a traffic light, it provides feedback to the emergency vehicle EVᵢ and forwards the vehicle's information to the subsequent roadside unit RSUⱼ₊₂.

The specific method for timestamp verification is as follows:

$$\vert {T}_{n}^{′} - {T}_{n} \vert \leq Δ T$$

Where Tₙ is the timestamp included in the message received in the previous phase, Tₙ′ is the current timestamp obtained by the device upon receiving the message, and ΔT is the threshold time allowed during the predetermined communication process. If the time difference exceeds the threshold time, the time is not fresh, the authentication process is terminated. If the time difference is less than the threshold time, the next step is carried out.

The messages {M₂, M₃, T₁}, {M₄, M₅, RIDⱼ, T₂}, {M₆, M₇, T₃}, {M₈, M₉, M₁₀, RIDⱼ, T₄}, {m₂, M₁₁, T₃} and {M₁₂, M₁₃, RIDⱼ, T₆} are all transmitted over a public channel.

Therefore, this invention has the following beneficial effects:

In this invention, both the communication between emergency vehicles and roadside units, and the communication between roadside units and traffic control units, as well as the communication between roadside units, undergo a mutual authentication process. This ensures the legitimacy and traceability of the identities of the authenticated parties.

By pre-transmitting the traffic light request messages and coordinating the traffic light system, this invention allows emergency vehicles to promptly obtain priority passage rights when approaching traffic lights. This reduces waiting time, ensures safe passage, and not only reduces rescue delays but also avoids the safety risks associated with traditional methods of directly running red lights. Therefore, this invention has significant advantages in improving safety efficiency and reducing rescue delays.

Considering that there may be multiple traffic lights intersection along rescue routes, a traffic light service request message propagation is designed to allow roadside units to proactively transmit and authenticate messages to the next roadside unit. This greatly reduces the computational costs of subsequent authentication and improves authentication efficiency. Additionally, the next roadside unit also communicates in advance with the traffic control units of the traffic lights within its area to arrange services, ensuring smooth passage for emergency vehicles throughout the route.

To prioritize vehicle privacy protection, the real identity of a vehicle can only be obtained by the vehicle itself and the trusted center. Other entities cannot directly access the real identity information of the vehicle. In the process of interacting with other entities, the vehicle uses pseudonyms to protect privacy. When transmitted over public channels, the pseudonyms are encrypted and not directly exposed. Through this approach, the system can effectively communicate and interact while protecting vehicle privacy.

This invention employs methods based on physical unclonable functions and biometric keys to protect the private keys of roadside units (RSUs) and emergency vehicles (EVs) when facing common attack techniques such as message forgery, tampering, malicious tracking, and physical attacks. It is designed based on timestamps, pseudonyms, and various encryption techniques such as elliptic curve encryption algorithms, elliptic curve Diffie-Hellman key exchange, etc. This design effectively resists common attacks and physical attacks.

The adoption of elliptic curve cryptography offers advantages such as shorter key length, higher strength, fewer parameters, faster digital signature, and smaller computational data volume. It is particularly suitable for devices with limited computing and storage resources.

FIG. 1 depicts the system architecture, which includes four entities: Trusted Authority (TA), Roadside Unit (RSU), Emergency Vehicle (EV), and Traffic Control Unit (TCU). The assumptions and working conditions of the system model are as follows:

Vehicles communicate with RSUs through an open channel using Dedicated Short-Range Communication (DSRC) protocol.

In this protocol, it is assumed that RSUs communicate with each other over an insecure channel, which is considered a public channel by default.

RSUs communicate with TCUs through an open channel.

TA is responsible for registering other entities (i.e., EVs, RSUs, and TCUs) in the network and distributing keys to them. Additionally, in the event of a vehicle accident, the institution can hold the vehicle accountable. TA is considered invulnerable to attacks.

RSUs are responsible for authenticating emergency vehicles, sending request messages to TCUs, providing feedback messages to EVs, and proactively sending emergency vehicle messages and identity information to the next RSU. Each RSU is equipped with a unique Physical Unclonable Function (PUF).

Emergency vehicles refer to vehicles that are permitted to pass through traffic lights quickly to perform specific tasks under certain circumstances.

TCU is the traffic control unit within traffic signal lights, responsible for controlling traffic signals and providing special services for emergency vehicles.

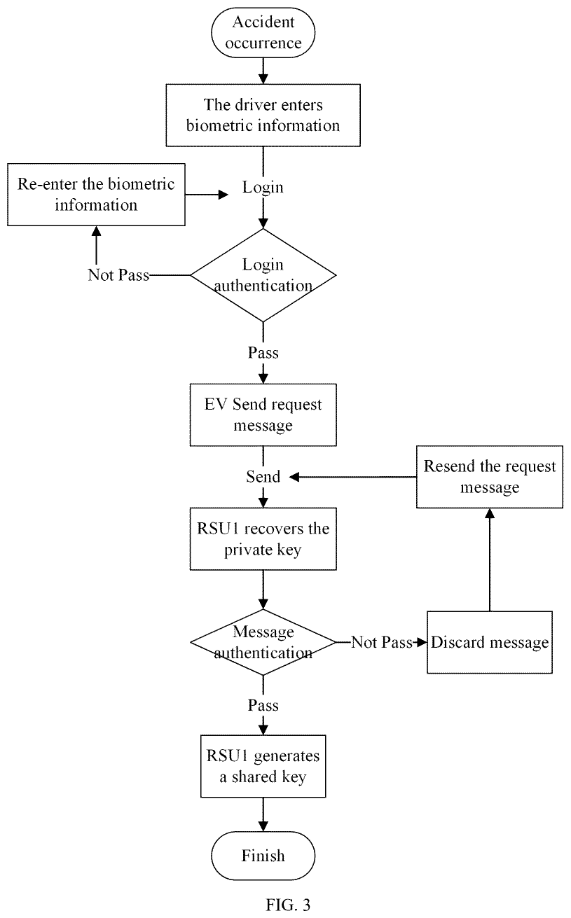

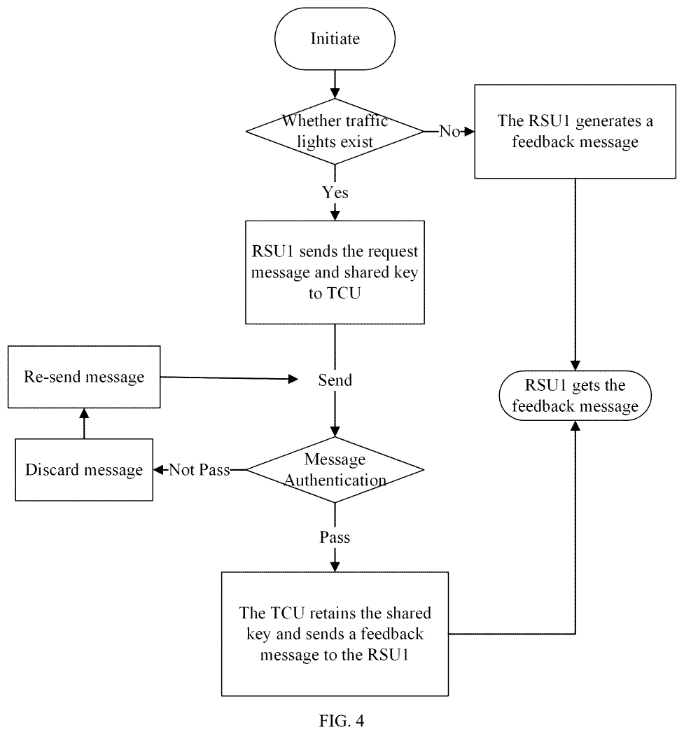

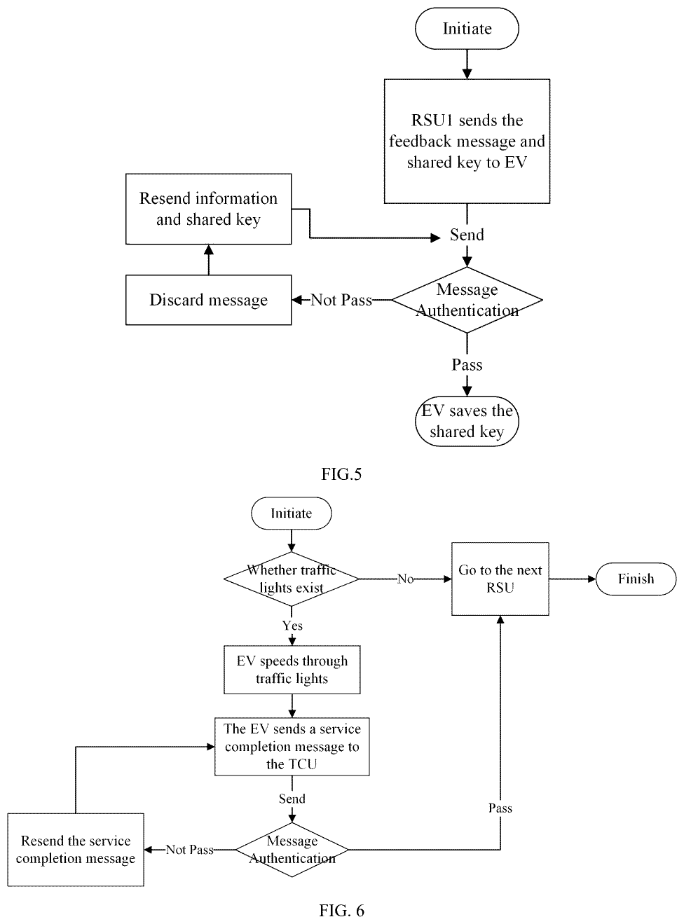

FIGS. 2 to 6 depict the process of the initial request for fast traffic light passage message authentication and the process of message propagation for fast traffic light passage, respectively.

The specific process of the initial request for fast traffic light passage message authentication is as follows:

After an accident occurs, the driver of the emergency vehicle enters their biometric information for login verification. If the verification fails, they can retry entering the biometric information until reaching the threshold for login attempts. If the verification is successful, the driver's identity is authenticated. The driver then sends the first request message for fast traffic light passage to the nearest roadside unit (RSU). The nearest RSU verifies the message using its private key. If the authentication fails, the RSU discards the message, and the vehicle resends the request message. If the authentication passes, a shared key is generated. The RSU checks if there are any traffic lights in the area. If traffic lights are present, the RSU sends the request message for fast traffic light passage, along with vehicle information and the shared key, to the traffic control unit (TCU). The TCU authenticates the message. If the authentication is successful, the TCU saves the vehicle information and shared key, and returns feedback information. If the authentication fails, the TCU discards the message, and the nearest RSU resends the message. If there are no traffic lights in the area, the nearest RSU generates its own feedback information. The RSU sends the feedback information and shared key to the vehicle, facilitating quick authentication switching. The vehicle authenticates the message. If the authentication passes, the shared key is stored, and appropriate measures are taken based on the feedback information. If traffic lights are present, the vehicle communicates with the TCU using the shared key to pass through the traffic light intersection quickly. Once the vehicle has passed the intersection, the TCU ends the service. If there are no traffic lights, the emergency vehicle directly passes through the area of the nearest RSU and proceeds to the next RSU area.

The specific process of message propagation for fast traffic light passage is as follows:

The emergency vehicle sends a request message for fast traffic light passage to the nearest roadside unit (RSU). The nearest RSU determines if there are traffic lights in the area. If traffic lights are present, the RSU propagates the message to the traffic control unit (TCU) and receives feedback information. If there are no traffic lights, the nearest RSU generates its own feedback information. The nearest RSU sends the feedback information to the emergency vehicle and propagates the traffic light request message to the next RSU. The next RSU anticipates whether there are traffic lights in its area. If traffic lights are present, the message is propagated to the TCU, and feedback information is obtained. If there are no traffic lights, the RSU generates its own feedback information. Simultaneously, the message is propagated to the third RSU, which prepares to receive the authentication request from the emergency vehicle and sends feedback information to the vehicle. This process of message propagation is repeated for each subsequent RSU until reaching the RSU located at the accident site, where it ends.

In this document, each embodiment is described progressively, focusing on the differences from other embodiments. The common or similar parts among the embodiments can be cross-referenced as needed.

The specific examples provided in this document illustrate the principles and implementation methods of the invention. The descriptions of the embodiments are intended to assist in understanding the core ideas of the invention. However, for those skilled in the art, changes may be made in the specific implementation methods and application scope based on the ideas of the invention. Therefore, the content of this document should not be construed as limiting the invention.

What is claimed is:

1. Authentication method for emergency vehicles to quickly pass through traffic lights, characterized by the following:
S1. System Initialization: The trusted authority (TA) selects a finite field Fₚ, a large prime number p, and an elliptic curve E: y²=x³+ax+b(mod p), where a, b∈Fₚ, G is the additive group with prime order q, P is a generator, Meanwhile, TA chooses a secure one-way hash function
$$h : {\{ 0 , 1 \}}^{*} \to {Z}_{q}^{*} ,$$
and randomly chooses a number
$$s ∈ {Z}_{q}^{*}$$
as the system's private key, and calculates the PK_{TA}=s·P as the corresponding public key, TA publishes system parameters params={G, E, P, p, q, a, b, h, PK_{TA}};
S2. Registration Phase: TA generates registration information for the emergency vehicles (EVs), roadside units (RSUs), and traffic control units (TCUs), Once each unit receives feedback on the registration information, the resulting secret parameters are protected and securely stored using physically unclonable functions (PUFs);
S3. Authentication Phase: In the event of an accident, the authentication phase enables emergency vehicles to swiftly pass through traffic lights, The process is as follows:
The emergency vehicle sends a traffic light message request to the nearest roadside unit, Upon receiving the message, the roadside unit first authenticates the legitimacy of the emergency vehicle's identity;
After successful authentication, the roadside unit determines whether there are traffic lights within its area, If a traffic light is present, the roadside unit sends the message to the traffic control unit inside the traffic light, The traffic control unit responds by sending feedback to the roadside unit, If no traffic light is present, the roadside unit generates its own feedback message and sends it to the emergency vehicle;
Once the emergency vehicle receives the feedback message from the roadside unit, it evaluates the content of the message, If a traffic light exists, the vehicle rapidly passes through the traffic light and sends a service completion message to the traffic control unit, If no traffic light is present, the vehicle proceeds directly to the next roadside unit domain.

2. According to the authentication method for emergency vehicles to quickly pass through traffic lights as claimed in claim 1, the specific process of the registration phase is characterized by the following:
S2.1. Emergency Vehicle Registration: The emergency vehicle EVᵢ selects an identity IDᵢ and randomly chooses a private key vⱼ during the registration stage, It calculates the corresponding public key PK_{EVi}=vᵢ·P and securely transmits {IDᵢ, PK_{EVi}} to the TA through a secure channel, TA selects a random number γᵢ and calculates the pseudonym PEVᵢ for the emergency vehicle EVᵢ as PEVᵢ=Encₛ(γᵢ∥IDᵢ), TA randomly selects a random number xᵢ and calculates Xᵢ=xᵢ·P, It also computes the identity verification parameter Certᵢ as Certᵢ=h(PEVᵢ∥Xᵢ∥PK_{EVi}∥PK_{TA})·s+xᵢ, TA then sends {Certᵢ, PEVᵢ, Xᵢ} to EVᵢ, When emergency vehicle EVᵢ receives the message, the driver verifies if Certᵢ·P=h(PEVᵢ∥Xᵢ∥PK_{EVi}∥PK_{TA})·PK_{TA}+Xᵢ is correct, If it is correct, the driver inputs their biometric information BIOᵢ and computes (αᵢ, βᵢ)=Gen(BIOᵢ), The onboard unit (OBU) of the vehicle selects a challenge value Cᵢ and calculates the response value Rᵢ=PUF(Cᵢ), It also computes
$${v}_{i}^{*} = {v}_{i} ⊕ h ( {R}_{i} ‖ 1 ) , {Cert}_{i}^{*} = {Cert}_{i} ⊕ h ( {R}_{i} ‖ 2 ) , {PRV}_{i}^{*} = {PEV}_{i} ⊕ h ( {R}_{i} ‖ 3 ) ,$$
$${C}_{i}^{*} = h ( {Cert}_{i} ‖ {PEV}_{i} ‖ {R}_{i} ‖ {v}_{i} ‖ {α}_{i} ‖ {ID}_{i} ) mod {n}_{0} ,$$
where n₀∈(2⁴, 2⁸), Finally,
$$\{ Rep ( \cdot ) , {β}_{i} , {v}_{i}^{*} , {PRV}_{i}^{*} , {Cert}_{i}^{*} , {C}_{i}^{*} , {X}_{i} , {PK}_{EVi} , {n}_{0} , {C}_{i} \}$$
are stored in the OBU;
S2.2. Roadside Units Registration: Firstly, TA selects a random integer uⱼ and an identity RIDⱼ for each roadside unit RSUⱼ (j=1, 2, 3, . . . ), The corresponding public key PK_{RSUj} is then calculated as PK_{RSUj}=uⱼ·P, Then, TA selects a shared secret value δₜ for the roadside unit RSUⱼ and its corresponding traffic control unit TCUₜ, It calculates Zⱼ=h(δₜ∥PK_{RSUj}∥RIDⱼ) and sends {uⱼ, δₜ, RIDₜ, Zⱼ} to RSUⱼ, When the roadside unit RSUⱼ receives the message, it computes the corresponding public key PK_{RSUj}=uⱼ·P and verifies if
$${Z}_{j}^{*} = h ( {δ}_{t} ‖ {PK}_{RSUj} ‖ {RID}_{j} )$$
is equal to Zⱼ, If they are equal, the roadside unit RSUⱼ selects a challenge value Cⱼ, calculates Rⱼ=PUF(Cⱼ), and updates its values as follows:
$${δ}_{t}^{*} = {δ}_{t} ⊕ h ( {R}_{j} ‖ {RID}_{j} ) and {u}_{j}^{*} = {u}_{j} ⊕ h ( {RID}_{j} ‖ {R}_{j} ) .$$
Finally, RSUⱼ stores
$$\{ {C}_{j} , {δ}_{t}^{*} , {u}_{j}^{*} , {PK}_{RSUj} , {RID}_{j} \}$$
in its storage unit;
S2.3. Traffic Control Unit Registration: Firstly, the TA selects a corresponding identity TIDₜ for the traffic control unit TCUₜ (t=1, 2, 3, . . . ), It then sends {δₜ, TIDₜ} to the traffic control unit TCUₜ over a secure channel, where δₜ is a shared secret value used for fast communication between the roadside unit RSUⱼ and the corresponding traffic control unit TCUₜ, When the traffic control unit TCUₜ receives the registration information from the trusted authority TA, it selects a challenge value Cₜ and calculates the corresponding response value Rₜ=PUF(Cₜ), Then, it computes
$${δ}_{t}^{*} = {δ}_{t} ⊕ h ( {R}_{t} ‖ {TID}_{t} )$$
and finally stores
$$\{ {δ}_{t}^{*} , {TID}_{t} \} .$$

3. The authentication method for emergency vehicles to quickly pass through traffic lights, as described in claim 2, is characterized by the following specific process in the authentication phase:
S3.1. Sending Request Message: The emergency vehicle EVᵢ sends a request message for quick passage through the traffic lights to the roadside unit RSUⱼ, When a driver wants to operate an emergency vehicle EVᵢ, the user must input their identity IDᵢ and biometric information BIOᵢ to verify legitimacy, Then, the emergency vehicle EVᵢ uses the recovery function and βᵢ of a fuzzy extractor to compute the biometric key αᵢ=Rep(BIOᵢ, βᵢ), It also calculates Rᵢ=PUF(Cᵢ),
$${v}_{i} = {v}_{i}^{*} ⊕ h ( {R}_{i} ‖ 1 ) , {Cert}_{i} = {Cert}_{i}^{*} ⊕ h ( {R}_{i} ‖ 2 ) ,$$
and pseudonym
$${PEV}_{i} = {PRV}_{i}^{*} ⊕ h ( {R}_{i} ‖ 3 ) ,$$
Next, the emergency vehicle EVᵢ computes
$${C}_{i}^{′} = h ( {Cert}_{i} ‖ {PEV}_{i} ‖ {R}_{i} ‖ {v}_{i} ‖ {α}_{i} ‖ {ID}_{i} ) mod {n}_{0}$$
and compares it with Cᵢ* stored in the onboard unit OBU, If they are not equal, re-login is required; otherwise, it indicates that the driver is legitimate, and the driver authentication is successful, When the emergency vehicle EVᵢ wants to pass through a traffic light intersection unimpeded, it sends a request message to the nearest roadside unit, Firstly, the emergency vehicle EVᵢ generates two random numbers r₁ and r₂, then computes M₁=r₁·P, M₂=Encₕ₍₍ᵣ_{₁}_{·PK}_{_{RSUj}}_{)∥T}_{₁}₎(r₂∥Xᵢ∥PK_{EVi}∥PEVᵢ∥M₁∥m₁∥T₁), where PK_{EVi} is the public key of the emergency vehicle EVᵢ, PEVᵢ is the pseudonym of the emergency vehicle EVᵢ, The emergency vehicle EVᵢ computes M₃=h(T₁∥PEVᵢ∥Xᵢ∥PK_{EVi}∥m₁∥PK_{TA}∥T₁)·vᵢ+Certᵢ, and sends {M₂, M₃, T₁} to the nearest roadside unit RSUⱼ, When RSUⱼ receives the messages, it first checks the timestamp T₁, If the time requirements are met, the nearest roadside unit RSUⱼ computes Rⱼ=PUF(Cⱼ) and recovers the private key uⱼ=uⱼ*⊕h(RIDⱼ∥Rⱼ), then decrypts (r₂∥Xᵢ∥PK_{EVi}∥PEVᵢ∥M₁∥m₁∥T₁)=Decₕ₍ᵤ_{ⱼ}_{·M}_{₁}_{)∥T}_{₁}₎(M₂) to get parameter Xᵢ, public key PK_{EVi}, pseudonym PEVᵢ, the point M₁ on the elliptic curve, request message m₁ quickly through traffic lights, Next, the nearest roadside unit RSUⱼ verifies if M₃·P [symbol] h(T₁∥PEVᵢ∥Xᵢ∥PK_{EVi}∥m₁∥PK_{TA}∥T₁)·PK_{EVi}+h(PEVᵢ∥Xᵢ∥PK_{EVi})·PK_{TA}+Xᵢ is correct, If it is correct, the nearest roadside unit RSUⱼ selects a random number r₃, and computes the shared secret key sk_{ER}=h(r₃·M₁) for the convenience of subsequent communication, including EV-to-TCU and EV-to-RSU, Otherwise, authentication is terminated immediately and the emergency vehicle resends the request;
S3.2. Existing Traffic Lights: RSUⱼ sends a quickly pass traffic lights request message to TCUₜ, If there is a traffic light within the range of the roadside unit RSUⱼ, the roadside unit RSUⱼ communicates with the traffic control unit TCUₜ, The roadside unit RSUⱼ generates timestamp T₂, and computes
$${δ}_{t} = {δ}_{t}^{*} ⊕ h ( {R}_{j} ‖ {RID}_{j} ) ,$$
M₄=Enc_{h(δ}_{ₜ}_{∥T}_{₂}₎(m₁∥sk_{ER}∥PEVᵢ), M₅=h(m₁∥sk_{ER}∥RIDⱼ∥PEVⱼ∥δₜ∥T₂), Then, the roadside unit RSUⱼ sends {M₄, M₅, RIDⱼ, T₂} to the traffic control units TCUₜ, When the traffic control units TCUₜ receives the messages from the roadside unit RSUⱼ, the traffic control units TCUₜ firstly checks timestamp T₂, If the time requirements are met, the traffic control unit TCUₜ computes the response value Rₜ=PUF(Cₜ), recovers the shared secret value
$${δ}_{t} = {δ}_{t}^{*} ⊕ h ( {R}_{t} ‖ {TID}_{t} ) ,$$
and based on the shared secret value and symmetric decryption algorithm between the roadside unit RSUⱼ and the traffic control unit TCUₜ, decrypts (m₁∥sk_{ER}∥PEVᵢ)=Dec_{h(δ}_{ₜ}_{∥T}_{₂}₎(M₄), Next, the traffic control unit TCUₜ computes
$${M}_{5}^{*} = h ( {m}_{1} ‖ {sk}_{ER} ‖ {RID}_{j} ‖ {PEV}_{i} ‖ {δ}_{c} ‖ {T}_{2} ) ,$$
and verifies
$${M}_{5} {=}^{?} {M}_{5}^{*} ,$$
If the verification fails, the authentication process will immediately terminate, If the verification is successful, the traffic control unit TCUₜ saves the shared key
$${sk}_{ER}^{*} = {sk}_{ER} ⊕ h ( {TID}_{t} ‖ {R}_{t} )$$
and generates feedback message m₂, It then stores
$$< {m}_{1} , {m}_{2} , {PEV}_{i} , {sk}_{ER}^{*} > ,$$
Meanwhile, the traffic control unit TCUₜ generates a timestamp T₃, and computes M₆=m₂ ⊕h(δₜ∥T₃) for encrypting the transmission of feedback message m₂, It also calculates M₇=h(m₂∥TIDₜ∥δₜ∥PEVᵢ∥T₃) for verifying the integrity of each parameter, Finally, it sends {M₆, M₇, T₃} to the roadside unit RSUⱼ, When the roadside unit RSUⱼ receives the information from the traffic control unit TCUₜ, it checks the timestamp T₃, If the time is fresh, the roadside unit RSUⱼ recovers the feedback message m₂=M₆⊕h(δₜ∥T₃), and calculates
$${M}_{7}^{*} = h ( {m}_{2} ‖ {TID}_{t} ‖ {δ}_{t} ‖ {PEV}_{i} ‖ {T}_{3} )$$
to verify if
$${M}_{7} {=}^{?} {M}_{7}^{*}$$
is correct, If the verification fails, the authentication process will immediately terminate, If the verification is successful, the roadside unit RSUⱼ sends a message to the emergency vehicle EVᵢ;
S3.3. Sending Feedback Message: The process by which the roadside unit RSUⱼ sends feedback messages to the emergency vehicle EVᵢ and EVᵢ receives feedback messages, The roadside unit RSUⱼ selects the timestamp T₄ and calculates M₈=r₃·P based on elliptic curve algorithm, where r₃ is a random number, Simultaneously, RSUⱼ calculates M₉=(m₂)⊕h(r₂∥sk_{ER}∥T₄) using the shared key sk_{ER} for encrypting the transmission of feedback message m₂, RSUⱼ also calculates M₁₀=h(M₉∥r₂∥m₂∥sk_{ER}∥M₈∥RIDⱼ∥T₄) for verifying the integrity of each parameter, RSUⱼ then sends {M₈, M₉, M₁₀, RIDⱼ, T₄} to the emergency vehicle EVᵢ, When the emergency vehicle EVᵢ receives a message from the roadside unit RSUⱼ, EVᵢ checks the timestamp T₄, If the time is fresh, EVᵢ calculates the shared key sk_{ER}=h(r₁·M₈), recovers the feedback message (m₂)=M₉⊕h(r₂∥sk_{ER}∥T₄), and verifies its validity by calculating M₁₀*=h(M₉∥r₂∥m₂∥sk_{ER}∥M₈∥RIDⱼ∥T₄) and comparing it with M₁₀, If the verification is successful, EVᵢ stores the shared key sk_{ER} and proceeds to cross the traffic light at the fastest speed;
S3.4. No Existing Traffic Lights: If there is no traffic light within the domain of the roadside unit RSUⱼ, RSUⱼ generates a feedback message
$${m}_{2}^{*}$$
indicating that there is no traffic light for direct passage and selects the timestamp T₄, Following the procedure outlined in S3.3, RSUⱼ sends the message to the emergency vehicle EVᵢ, The only difference is that the feedback message m₂ generated by the traffic control unit TCUₜ is replaced by
$${m}_{2}^{*} ;$$
S3.5. Service Completion: Traffic control unit TCUₜ adjusts traffic light to complete service, When the emergency vehicle EVᵢ approaches the traffic light, EVᵢ generates a timestamp T₅, Using a symmetric encryption algorithm, EVᵢ encrypts the feedback message m₂ and the emergency vehicle pseudonym PEVᵢ as M₁₁=Encₛₖ_{_{ER}}(m₂∥PEVᵢ∥T₅), EVᵢ then sends the message {m₂, M₁₁, T₅} to the traffic control unit TCUₜ for transmission, When the traffic control unit TCUₜ receives messages from the emergency vehicle EVᵢ, TCUₜ first checks the timestamp T₅, If the time is fresh, TCUₜ uses the feedback information m₂ to find the corresponding <m₁, m₂, PEVᵢ,
$${sk}_{ER}^{*} > ,$$
TCUₜ then recovers the session key sk_{ER} by performing the operation
$${sk}_{ER} = {sk}_{ER}^{*} ⊕ h ( {TID}_{t} ‖ {R}_{t} ) ,$$
Next, TCUₜ decrypts
$$( {m}_{2} ‖ {PEV}_{i}^{*} ‖ {T}_{5} )$$
by using the decryption function
$$( {m}_{2} ‖ {PEV}_{i}^{*} ‖ {T}_{5} ) = {Dec}_{{SK}_{ER}} ( {M}_{11} ) , {TCU}_{t}$$
compares the computed pseudonym
$$P E {V}_{i}^{*}$$
with the stored pseudonym PEVᵢ, If they are identical, it indicates that the task message is from the emergency vehicle EVᵢ, TCUₜ adjusts the traffic light accordingly to facilitate the emergency vehicle's quick passage and concludes the service;
S3.6. Transmitting Request Message: The current roadside unit RSUⱼ forwards the traffic light request message to the next roadside unit RSUⱼ₊₁, The roadside unit RSUⱼ generates timestamp T₆, and calculates M₁₂=Encₕ₍ᵤ_{ⱼ}_{·PKRSU}_{ⱼ₊₁}_{)∥T}_{₆}₎(m₁∥sk_{ER}∥PEVᵢ) using symmetric encryption, RSUⱼ also calculates M₁₃=h(m₁∥sk_{ER}∥PEVᵢ∥M₁₂∥RIDⱼ∥RIDⱼ₊₁∥T₆), and sends {M₁₂, M₁₃, RIDⱼ, T₆} to the next roadside unit RSUi+1, When the next roadside unit RSUⱼ₊₁ receives messages from the current roadside unit RSUⱼ, the next roadside unit RSUⱼ₊₁ firstly checks timestamp T₆, If the time is fresh, the next roadside unit RSUⱼ₊₁ computes response value Rⱼ₊₁=PUF(Cⱼ₊₁) and recovers private key
$${u}_{j + 1} = {u}_{j + 1}^{*} ⊕ h ( {RID}_{j + 1} ‖ {R}_{j + 1} ) ,$$
Then RSUⱼ₊₁ decrypts (m₁∥sk_{ER}∥PEVᵢ) as (m₁∥sk_{ER}∥PEVᵢ)=Decₕ₍₍ᵤ_{ⱼ₊₁}_{·PK}_{_{RSUj}}_{)∥T}_{₆}₎(M₁₂), obtaining the requested message m₁, the shared secret key sk_{ER} and the emergency vehicle pseudonym PEVᵢ, RSUⱼ₊₁ validates the decrypted parameters by calculating
$${M}_{13}^{*} = h ( {m}_{1} ‖ {sk}_{ER} ‖ {PEV}_{i} ‖ {M}_{12} ‖ {RID}_{j} ‖ {RID}_{j + 1} ‖ {T}_{6} )$$
and comparing it with M₁₃ to check for equality, If the validation is successful, RSUⱼ₊₁ calculates
$${sk}_{ER}^{*} = {sk}_{ER} ⊕ h ( {RID}_{j + 1} ‖ {R}_{j + 1} )$$
to be used for encrypting and storing the shared key sk_{ER}, Finally, RSUⱼ₊₁ stores the tuple <m₁,
$${PEV}_{i} , {sk}_{ER}^{*} 〉 ,$$
If there is a traffic light within the current roadside unit RSUⱼ, the roadside unit RSUⱼ₊₁ follows the procedure outlined in S3.2 to transmit vehicle information to the traffic control unit TCU responsible for controlling the current traffic light, It then receives feedback message m₂, Subsequently, the emergency vehicle EVᵢ, after entering the next roadside unit RSUⱼ₊₁, communicates with the TCU within the domain and swiftly passes through the traffic light, following a similar process as before, However, if the roadside unit RSUⱼ₊₁ does not have a traffic light, it provides feedback to the emergency vehicle EVᵢ and forwards the vehicle's information to the subsequent roadside unit RSUⱼ₊₂.

4. The authentication method for enabling emergency vehicles to pass through traffic lights quickly, as described in claim 3, is characterized by the verification method of the timestamp, as follows:
$$\vert {T}_{n}^{′} - {T}_{n} \vert \leq Δ T ;$$
Where Tₙ is the timestamp included in the message received in the previous phase,
$${T}_{n}^{′}$$
is the current timestamp obtained by the device upon receiving the message, and ΔT is the threshold time allowed during the predetermined communication process, If the time difference exceeds the threshold time, the authentication process is terminated, If the time difference is less than the threshold time, the next step is carried out.

5. The authentication method for enabling emergency vehicles to pass through traffic lights quickly, as described in claim 3, is characterized by the fact that the messages {M₂, M₃, T₁}, {M₄, M₅, RIDⱼ, T₂}, {M₆, M₇, T₃}, {M₈, M₉, M₁₀, RIDⱼ, T₄}, {m₂, M₁₁, T₅} and {M₁₂, M₁₃, RIDⱼ, T₆} are all transmitted over a public channel.
